(19) United States
(12) Patent Application Publication
(10) Pub. No.: US 2024/0282081 A1
(43) Pub. Date: Aug. 22, 2024

(54) DYNAMIC TEMPORAL FUSION FOR VIDEO RECOGNITION

(71) Applicant: QUALCOMM Incorporated, San Diego, CA (US)

(72) Inventors: Juntae LEE, Seoul (KR); Sungrack YUN, Seongnam (KR)

(21) Appl. No.: 18/504,968

(22) Filed: Nov. 8, 2023

Related U.S. Application Data
(60) Provisional application No. 63/486,212, filed on Feb. 21, 2023.

(51) Int. Cl. G06V 10/764; G06V 10/44; G06V 10/62; G06V 10/82

(52) U.S. Cl. CPC G06V 10/764; G06V 10/44; G06V 10/62; G06V 10/82

(57) ABSTRACT

Systems and techniques are described herein for performing dynamic temporal fusion for video classification, such as recognition, detection, and/or other form of classification. For example, a computing device can generate, via a first network, frame-level features obtained from a set of input frames. The computing device can generate, via a first multi-scale temporal feature fusion engine, first local temporal context features from a first neighboring sub-sequence of the set of input frames. The computing device can generate, via a second multi-scale temporal feature fusion engine, second local temporal context features from a second neighboring sub-sequence of the set of input frames. The computing device can further classify the set of input frames based on the first local temporal context features and the second local temporal context features.

### CROSS-REFERENCE TO RELATED APPLICATIONS

This application claims priority to U.S. Provisional Patent Application No. 63/486,212, filed Feb. 21, 2023, which is hereby incorporated by reference, in its entirety and for all purposes.

### FIELD

Aspects of the present disclosure generally relate to video recognition. For example, aspects of the present disclosure relate to systems and techniques for generating video representations that convey different temporal dynamics at different temporal periods of video recognition.

### INTRODUCTION

Convolutional neural networks (CNNs) can be used for various recognition tasks. CNNs are a network architecture for deep learning that learns directly from data and are used to find patterns in images to recognize objects, classes or categories. For example, a CNN can be trained to identify a type of vehicle or an animal that might be in an image. CNNs can also be used for video recognition. However, with video recognition, there is a need for temporal modeling that does not exist in image recognition.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, the techniques described herein relate to an apparatus for performing video action classification, including: at least one memory; and at least one processor coupled to at least one memory and configured to: generate, via a first network, frame-level features obtained from a set of input frames; generate, via a first multi-scale temporal feature fusion engine, first local temporal context features from a first neighboring sub-sequence of the set of input frames; generate, via a second multi-scale temporal feature fusion engine, second local temporal context features from a second neighboring sub-sequence of the set of input frames; and classify the set of input frames based on the first local temporal context features and the second local temporal context features.

In some aspects, the techniques described herein relate to a method of classifying video, the method including one or more of: generating, via a first network, frame-level features obtained from a set of input frames; generating, via a first multi-scale temporal feature fusion engine, first local temporal context features from a first neighboring sub-sequence of the set of input frames; generating, via a second multi-scale temporal feature fusion engine, second local temporal context features from a second neighboring sub-sequence of the set of input frames; and classifying the set of input frames based on the first local temporal context features and the second local temporal context features.

In some aspects, the techniques described herein relate to a non-transitory computer-readable medium having stored thereon instructions that, when executed by one or more processors, cause the one or more processors to be configured to: generate, via a first network, frame-level features obtained from a set of input frames; generate, via a first multi-scale temporal feature fusion engine, first local temporal context features from a first neighboring sub-sequence of the set of input frames; generate, via a second multi-scale temporal feature fusion engine, second local temporal context features from a second neighboring sub-sequence of the set of input frames; and classify the set of input frames based on the first local temporal context features and the second local temporal context features. One or more of these operations can be performed by the non-transitory computer-readable medium.

In some aspects, the techniques described herein relate to an apparatus for generating virtual content in a distributed system, the apparatus including one or more of: means for generating, via a first network, frame-level features obtained from a set of input frames; means for generating, via a first multi-scale temporal feature fusion engine, first local temporal context features from a first neighboring sub-sequence of the set of input frames; means for generating, via a second multi-scale temporal feature fusion engine, second local temporal context features from a second neighboring sub-sequence of the set of input frames; and means for classifying the set of input frames based on the first local temporal context features and the second local temporal context features.

In some aspects, the techniques described herein relate to an apparatus for performing video classification, including one or more of: a neural network configured to generate frame-level features in consecutive frames from a set of video frames; a first multi-scale temporal feature fusion engine having a first kernel size configured to generate first local context features based on the frame-level features; a second multi-scale temporal feature fusion engine having a second kernel size configured to generate second local context features based on the frame-level features; a first temporal-relation cross transformer classifier configured to generate a first distance between a query video associated with the set of video frames and sets of support videos based on the first local context features; a second temporal-relation cross transformer classifier configured to generate a second distance between a query video associated with the set of video frames and the sets of support videos based on the second local context features; and a calculating engine configured to calculate a final distance between the query video and the sets of support videos based on the first distance and the second distance.

In some aspects, the techniques described herein relate to a method of performing video classification, the method including one or more of: generating, via a neural network configured to receive a set of video frames, frame-level features in consecutive frames from the set of video frames; generating, via a first multi-scale temporal feature fusion engine having a first kernel size, first local context features based on the frame-level features; generating, via a second multi-scale temporal feature fusion engine having a second kernel size, second local context features based on the frame-level features; generating, via a first temporal-relation cross transformer classifier and based on the first local context features, a first distance between a query video associated with the set of video frames and sets of support videos; generating, via a second temporal-relation cross transformer classifier and based on the second local context features, a second distance between a query video associated with the set of video frames and the sets of support videos; and calculating a final distance between the query video and the sets of support videos based on the first distance and the second distance.

In some aspects, the techniques described herein relate to a non-transitory computer-readable medium having stored thereon instructions that, when executed by one or more processors, cause the one or more processors to be configured to: generate, via a neural network configured to receive a set of video frames, frame-level features in consecutive frames from the set of video frames; generate, via a first multi-scale temporal feature fusion engine having a first kernel size, first local context features based on the frame-level features; generate, via a second multi-scale temporal feature fusion engine having a second kernel size, second local context features based on the frame-level features; generate, via a first temporal-relation cross transformer classifier and based on the first local context features, a first distance between a query video associated with the set of video frames and sets of support videos; generate, via a second temporal-relation cross transformer classifier and based on the second local context features, a second distance between a query video associated with the set of video frames and the sets of support videos; and calculate a final distance between the query video and the sets of support videos based on the first distance and the second distance. One of more of the above operations can be performed.

In some aspects, the techniques described herein relate to an apparatus for generating virtual content in a distributed system, the apparatus including one or more of: means for generating, via a neural network configured to receive a set of video frames, frame-level features in consecutive frames from the set of video frames; means for generating, via a first multi-scale temporal feature fusion engine having a first kernel size, first local context features based on the frame-level features; means for generating, via a second multi-scale temporal feature fusion engine having a second kernel size, second local context features based on the frame-level features; means for generating, via a first temporal-relation cross transformer classifier and based on the first local context features, a first distance between a query video associated with the set of video frames and sets of support videos; means for generating, via a second temporal-relation cross transformer classifier and based on the second local context features, a second distance between a query video associated with the set of video frames and the sets of support videos; and means for calculating a final distance between the query video and the sets of support videos based on the first distance and the second distance.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates a multi-scale temporal feature fusion engine for a sequence of frame-level features for a video, in accordance with some examples;

FIG. 2 illustrates the use of multiple multi-scale temporal feature fusion engines for a sequence of frame-level features for the video in a classifier, in accordance with some examples;

FIG. 3 is a flow diagram illustrating an example of a process for performing multi-scale temporal feature fusion, in accordance with some examples;

FIG. 4 is a flow diagram illustrating an example of a process for classifying a video using multiple multi-scale temporal feature fusion engines using different kernel sizes, in accordance with some examples; and

FIG. 5 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A video that is fed into a convolutional neural network (CNN) for video recognition can include temporal dynamics as well as spatial appearance. A two-dimensional CNN may process a video representation but such a CNN is usually applied on individual frames and cannot model temporal information of video. The two-dimensional CNN processes data by sliding a kernel along two dimensions of the data, such as along an image width and an image height. The two-dimensional CNN can extract the spatial features (e.g., edges, color distribution, and so forth) from the data using its kernel. Three-dimensional CNNs can jointly learn spatial and temporal features but the computation cost is large, making deployment on edge devices (e.g., edge devices that provide an entry point into a service provider core network, such as aa router, switch, multiplexer or other device) difficult. A three-dimensional CNN can be used with three-dimensional image data such as magnetic resonance imaging (MRI) data or video data. In a three-dimensional CNN, the kernel moves in three directions and the input and output data of the three-dimensional CNN is four dimensional. What is needed in the art is a new approach to designing effective video representations to tackle these challenges.

Given the problem of using two-dimensional CNNs, a spatial average pooling approach is often applied to summarize the width×height sized feature as a one-dimensional-feature at the last layer of a neural network. The use of spatial average pooling can preserve overall image-level characteristics. The use of spatial average pooling can also reduce the complexity of the feature.

Systems and techniques are described herein for generating video representations that convey different temporal dynamics at different temporal periods of video recognition. The video processing can make the video representations more robust. In some cases, the systems and techniques can include extracting and merging temporal information at different frame rates. In some aspects, the systems and techniques provide effective video representations to enable video recognition by convolutional neural networks or other networks. In some examples, the systems and techniques introduce a temporal fusion (also referred to as a temporal module) engine, which may be on top of certain features (e.g., the average-pooled feature) of two-dimensional CNNs.

A video input (e.g., a sequence of image or video frames) can include a sequence of one-dimensional-features. In videos, different temporal dynamics can be conveyed at different temporal granularities (e.g., different frame-rates), which can make the video representation more robust. For example, a fine-grained frame-level feature may show less temporal dynamics than a tuple-level (a set of neighboring frames) feature. The systems and techniques described herein can extract and merge temporal information to leverage temporal dynamics from the features in diverse temporal granularity.

In some cases, the system and techniques described herein can improve the classification (e.g., recognition, detection, etc.) of a video based on support videos. For example, a system can be trained with five classes from five support videos. The example approach may be characterized as a five-way, five-shot classification. The five support videos may include, for example, one video for vehicles, one video for animals, one video for buildings, one video for plants and one video for tools. The input query videos will be processed as described herein to classify the input query videos into one of these classes. A distance value can be calculated between the query video and the set of support videos and a classification probability can be calculated over the classes which in some aspects can be related to the negative value of the distance.

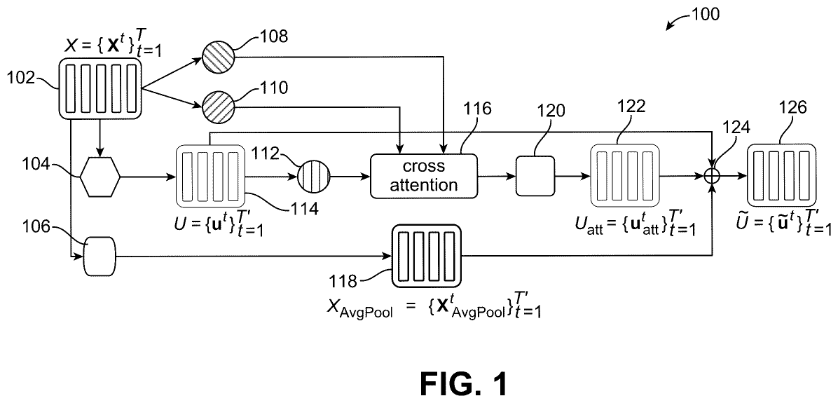

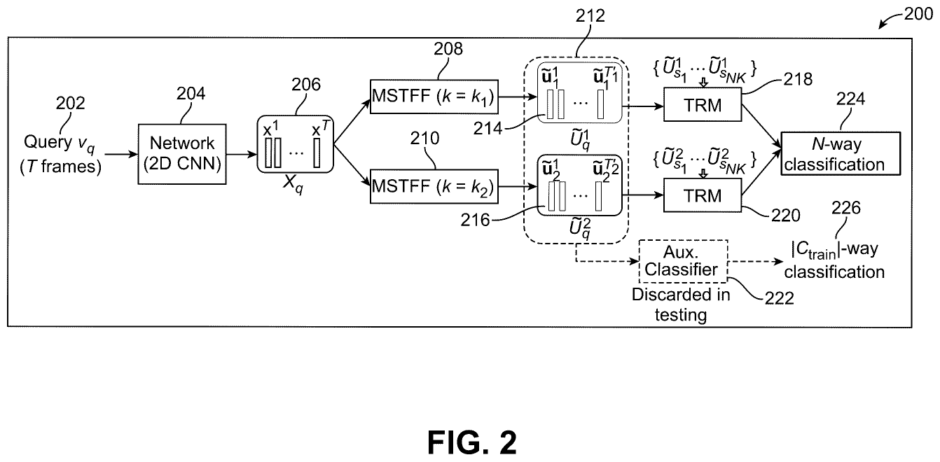

This system and techniques can recognize actions of interest that are identified by the support videos in testing (query) videos. In some cases, the system and techniques can include a multi-scale temporal feature fusion (MSTFF) module (e.g., as described below with respect to FIG. 1), where the features describing local temporal contexts in videos are enhanced by collaboratively merging important information in frame-level features (e.g., with no temporal context). In some examples, the systems and techniques can classify input videos by utilizing multiple MSTFF modules varying the scope of local temporal context extraction (e.g., as described below with respect to FIG. 2). The system can obtain a discriminative video representation which can be useful in a few-shot task where support videos are not sufficient (e.g., a case where there are not enough support videos) to describe an action class. For stable learning of a model with MSTFF and the performance boost, the systems and techniques can include learning a local temporal context-level auxiliary classifier in parallel with the main classifier (e.g., as described below with respect to FIG. 2).

FIG. 1 illustrates an example of a MSTFF module 100 for processing a sequence of frame-level features for a video. Action recognition has been widely studied in deep learning, but most methods require large-scale video datasets as noted above. When addressing fine-grained action classes, it is time-consuming to collect massive videos labeled by the various kinds of classes. Further, a learned deep network can face videos whose action classes are unseen during training. Hence, few-shot action recognition aims to recognize fine-grained actions in testing videos based on meager support videos whose action classes are unseen in training. In other words, few-shot action recognition aims to recognize action classes from input videos with few training samples or few support videos used for training a model.

Since support videos are not enough to reliably represent an action class in the few-shot setting, it is helpful to extract meaningful temporal information to describe the actions of interest from videos. The meaningful cues are included in parts of a video rather than over all the frames in the video, it is also helpful to reliably describe sub-actions in the video. However, a challenge exists due to the speed and the start and end time of an action being diverse depending on the videos. To resolve such a challenge, the tuples of the frames of query and support videos can be matched at multiple cardinalities. To further improve such an approach, better sub-sequence representation can be generated considering the spatial context in frames as well as the temporal context. In some cases, a hierarchical matching model can use coarse-to-fine cues in spatial and temporal domains, respectively.

The frame-level features from a backbone network (e.g., a two-dimensional CNN) may already include some information for the spatial context. To take advantage of the information for the spatial context, the systems and techniques described herein provide a collaborative fusion of two different types of features in different temporal scales: frame-level features and features for the temporal local context in the sub-sequences of video frames.

In some aspects, the systems and techniques can utilize the MSTFF module 100 shown in FIG. 1. The MSTFF module 100 can generate robust temporal local context representations preserving the important information in the frame-level features for an input video represented by frame-level features X 102. For example, the MSTFF module 100 can extract local temporal context information from neighboring frame-level features. A cross-attention module 116 can propagate highly relevant frame-level features to the features including the local temporal context. For example, through the cross-attention module 116, two features in different temporal scales are combined with high compatibility. Additionally, a local temporal context-level auxiliary classifier (as shown in FIG. 2 but not in FIG. 1) can be used that induces stable learning of the model and boosts the few-shot action recognition performance, which is discarded at the testing phase.

The MSTFF module 100 illustrates a combination of a one-dimensional convolution layer 104 (which can in some aspects be temporal in nature) and a cross attention module 116. The one-dimensional convolution layer 104 (e.g., with a kernel size k) can summarize the information in a consecutive k frames resulting in outputs U 114 which can also be called a key 110. The cross-attention module 116 receives a query 112 (e.g., a value U can represent coarse-grained features) and a key 110, and a value 108 (e.g., a parameter X can represent fine-grained features) and can process the data by providing a weighted sum of values based on a relationship between the query 112 and the key 110. The described process can mean transferring the knowledge of fine-grained features (before the one-dimensional convolution layer 104) to the coarse-grained ones (after the one-dimensional convolution layer 104). There also can be a skip-connection to preserve the information of the query features. The cross-attention module 116 can convey information from two different temporal granularities (e.g., for a frame-level & a tuple-level).

Due to the challenge of addressing videos in the few-shot regime, much effort has been put into the problem. While memory networks are exploited to obtain key-frame representations in some cases, different length query and support videos can be aligned. In other cases, monotonic temporal ordering is suggested to enhance temporal consistency between video pairs. The temporal relationships between query and support videos have been modeled using multiple lengths of temporal sub-sequences. Then, query-specific action class prototypes are generated and matched with the query video features. The disclosed approach can also provide further improvements by using richer video representations which can be obtained by using both spatial and temporal context as disclosed herein. Query-support matching also can be performed in both spatial and temporal levels with hierarchical contrastive learning to alleviate the complexity of the spatio-temporal matching.

A video or query v can be represented by a sequence of uniformly sampled T frames. A backbone network (e.g., a convolutional network or network 204 of any type and that is not shown in FIG. 1 but is shown in FIG. 2) can generate frame-level features X={x¹, . . . , x^{T}} 102 where x^{t}∈ [symbol] .

For the frame-level features X 102, The MSTFF module 100 can apply a one-dimensional convolution layer 104 along a temporal axis, called the temporal one-dimensional convolution, to obtain local temporal context features from neighboring sub-sequence of the frames by:

$$U = X ⊙ {w}_{k} \qquad ( 1 )$$

where ⊙ denotes the convolution operation along temporal axis, wₖ denotes a weight of the one-dimensional convolutional layer 104. k is the kernel size of wₖ(k<T). The length of the sequence U is T′ where T′<T. Then, U={u¹, . . . , u^{T′}} 114 represents the local temporal context information.

In order to propagate the important frame-level information in X to the local temporal context features, the system can apply a cross-attention module 116 to attend U 114 (which can be represented as a key 110) by frame-level features X 102. The process can be referred to as crossattention. The feature sequences U 114 and the frame-level features X 102 can be projected to queries {q^{t}}ₜ₌₁^{T′} 112 and key-value pairs {k^{t}, v^{t})}ₜ₌₁^{T′}, (e.g., key 110 and value 108) respectively. Here, q^{t}∈ [symbol] , k^{t}∈ [symbol] , and v^{t}∈ [symbol] .

The cross-attended feature uₐₜₜ^{t} 122 for u^{t} is computed by

$${u}_{a t t}^{t} = {\sum }_{i} \frac{exp ( \frac{{q}^{t \cdot {k}^{i}}}{τ} )}{{\sum }_{r} exp ( \frac{{q}^{r \cdot {k}^{r}}}{τ} )} \cdot {v}^{i} \qquad ( 2 )$$

where the temperature t is set to the square root of a key's dimensionality in order to scale the dot-product of the query 112 and the key 110. The computation can be performed by component or module 120 which can perform, for example, a bn-tan h (batch-normalization tan h) operation. Tan h is a hyperbolic tangent function. The batch-normalization can be performed before a tan h operation. In the first part of a batch-normalization algorithm, the mean and standard deviation of the batch of activations can be calculated. The mean can be subtracted from each activation value, and then each will be divided by the batch's standard deviation. The expected value of any activation is now zero, which is the central value of the input to the tan h function and the standard deviation of an activation is one which means that most activation values will be between [−1, 1].

Additionally, to obtain the local temporal context in a more diverse view, the system also combines uₐₜₜ^{t} 122 with neighboring frame-level features 118 by simple average pooling via an average pooling module 106 (e.g., by one-dimensional average pooling) on the frame-level features X 102 along the temporal axis, which results in frame-level features {x_{AvgPool}^{t}}ₜ₌₁^{T′} 118.

Lastly, the final enhanced local temporal context features Ũ={ũ^{t}}ₜ₌₁^{T′} 126 are generated, via a summing component 124, by:

$${\tilde{u}}^{t} = {u}_{a t t}^{t} + {x}_{AvgPool}^{t} + {u}^{t} \qquad ( 3 )$$

The approach leverages the frame-level and temporal-level context collaboratively. The average pooling module 106 can provide information of temporally neighboring frames at a single temporal granularity. The cross-attended features (e.g., the query 112, the value 108, the key 110) and temporally average pooled features 118 can be summed by the summing component 124 to generate the final features Ũ={ũ^{t}}ₜ₌₁^{T′} 126.

Notice that in equation (1), varying k (the kernel), the system can adjust the scope of local temporal context information. Experimentally, one can use two different k={k₁, k₂} or kernel values as shown in FIG. 2 in consideration of the diversity of the duration of actions.

FIG. 2 illustrates the use of multiple multi-scale temporal feature fusion engines for a sequence of frame-level features for a video processed by a classifier 200. To obtain the initial representations or T frame-level features 206 of the input query and support videos, the system can uniformly sample T frames 202 per video and employ a network 204. The network 204 can be any number of different networks such as a backbone network including a two-dimensional convolutional neural network. The ResNet backbone is an example network which is a “Residual Network” backbone network that is a class neural network used for computer vision tasks. Other neural networks can be used as well. In some aspects, the network 204 can be a pre-trained network on an image dataset such as the ImageNet dataset. It can be a two-dimensional CNN without any temporal module and hence may only perform frame-level information extraction for a sequence of input frames. In some aspects, the network 204 can be a backbone network such as a high-resolution network HRNet-48 as is known in the art. The network 204 extracts T frame-level features 206 for each video. Then, the respective MSTFF module 208, 210 generates a sequence of T′ features describing the local temporal context. The resulting temporal context features 214, 216 (combined as a pair of local temporal context features 212) from support and query videos are fed into the final respective classifier 218, 220. Example classification modules include temporal relation matching (TRM) classification modules.

In some aspects, a last convolution module of the network 204 (e.g., such as the HRNet-48) can be replaced with a temporal fusion engine (e.g., the MSTFF module 100 or other baseline components).

In a testing phase of the few-shot action recognition, an input testing video can be classified into one of C classes where each class is described by a handful K support videos and the classes are unseen during training. The system (e.g., the MSTFF module 100) can set K>1.

A meta-learning strategy can be used. In such a strategy, action classes in training set Cₜᵣₐᵢₙ and testing set Cₜₑₛₜ are not overlapped. Then, to simulate the few-shot configuration of support and query videos that will occur in testing, the system (e.g., the MSTFF module 100 or the classifier 200) can exploit the episodic training to simulate the few-shot tasks. For example, at a particular training iteration, N classes can be randomly selected from Cₜᵣₐᵢₙ. and then K support and [symbol] query videos can be randomly sampled in each class n. In some aspects, the system (e.g., the MSTFF module) can denote the support set and query set as Vs and Vo, respectively. An N-way classification module 224 can produce the output of the classifier 200.

In episodic few-shot learning, an auxiliary classifier 222 can be jointly trained to categorize the input query into one of the ground-truth training classes rather than the target N classes of a given episode. The approach is beneficial for the network 204 to prevent overfitting and boost the few-shot N-way classification performance.

In an alternative example, the system (e.g., the MSTFF module) can include the auxiliary classifier 222 on top of the MSTFF module which can include two MSTFF modules 208, 210 each using a respective kernel value k₁, k₂. The design the auxiliary classifier can include in some aspects a two-layer multilayer perceptron (MLP). Then, each of the enhanced temporal context features ũ^{t} 214, 216 can be fed into the auxiliary classifier 222, and the auxiliary classifier 222 is learned to classify data into one of |Cₜᵣₐᵢₙ| classes. The ground-truth label can be shared for all (t, k) in the same video. From the auxiliary classifier 222 (e.g., a local temporal context-based classifier) each temporal context feature can better represent the action cues. In one aspect, the auxiliary classifier 222 is discarded in the deployed model.

In some aspects, the auxiliary classifier 222 classifies the input query videos into one of the entire training class pool, which helps stable few-shot learning. The output can be a multi-way classification, such as the c-way classification 226 shown in FIG. 2. In one aspect, the auxiliary classifier 222 is not deployed in testing.

Each of the query and support videos can be passed through the MSTFF modules 208, 210. Since the MSTFF modules 208, 210 have different k (kernel) values as described above, the system can use different classifiers 218, 220 (e.g., TRM classifiers) for each MSTFF module 208, 210. A respective classifier 218, 220 can output distances dₖ={dₖ¹, . . . , dₖ^{N}} between a query video and N sets of support videos. The system obtains the final distance d between the query and support videos by accumulating the distances from all k: d=d₁+d₂. Then, the classification probability over class n is computed by

$${p}^{n} ( {v}_{q} ) = \frac{exp ( - {d}^{n} )}{{\sum }_{{n}^{′} ∈ N} exp ( - {d}^{n} )} \qquad ( 4 )$$

which is proportional to the negative of the distance. The value is used to ultimately classify the video into one of the classes.

In some aspects, the system can optimize the model by using a cross-entropy loss for N-way classification as the main loss:

$${ℒ}_{m a i n} = - \frac{1}{\vert {V}_{Q} \vert} {\sum }_{( {v}_{q ,} {y}_{q} )} log {p}^{{y}_{q}} ( {v}_{q} ) \qquad ( 5 )$$

The system can also use an additional cross-entropy loss to learn the auxiliary classifier:

$${ℒ}_{aux} = - \frac{1}{\vert {V}_{Q} \vert \vert {N}_{u} \vert} {\sum }_{( {v}_{q} , {y}_{q}^{a u x} )} {\sum }_{\{ {\tilde{u}}_{k}^{t} \}} log {μ}^{{y}_{q}^{aux}} ( {\tilde{u}}_{k}^{t} ) \qquad ( 6 )$$

Where y_{q}^{aux}∈{1, . . . , |Cₜᵣₐᵢₙ|} is the auxiliary ground-truth label, and the corresponding softmax probability

$${μ}^{{y}_{q}^{aux}}$$

is computed based on |Cₜᵣₐᵢₙ| outputs from the auxiliary classifier 222. |Nₛ|=T₁′+T₂′ where T₁′ and T₂′ are the number of the final enhanced temporal context features for k₁ and k₂, respectively. Finally, the total loss is given by [symbol] = [symbol] ₘₐᵢₙ+ [symbol] ₐᵤₓ.

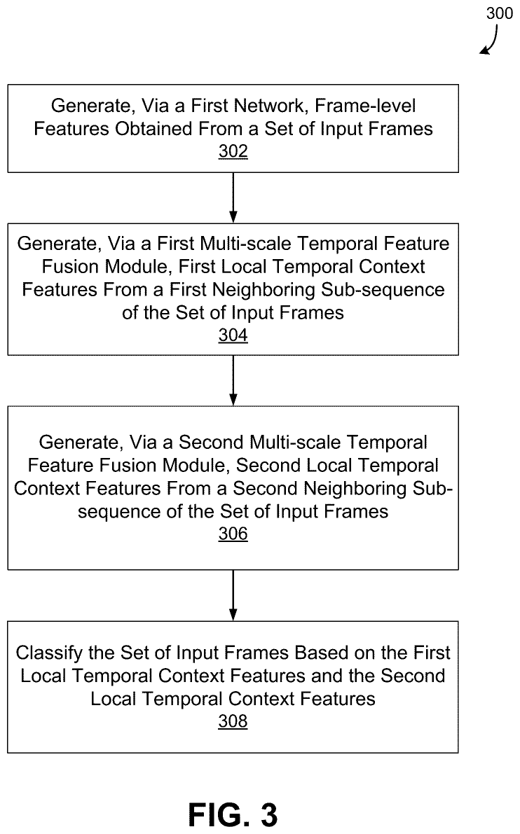

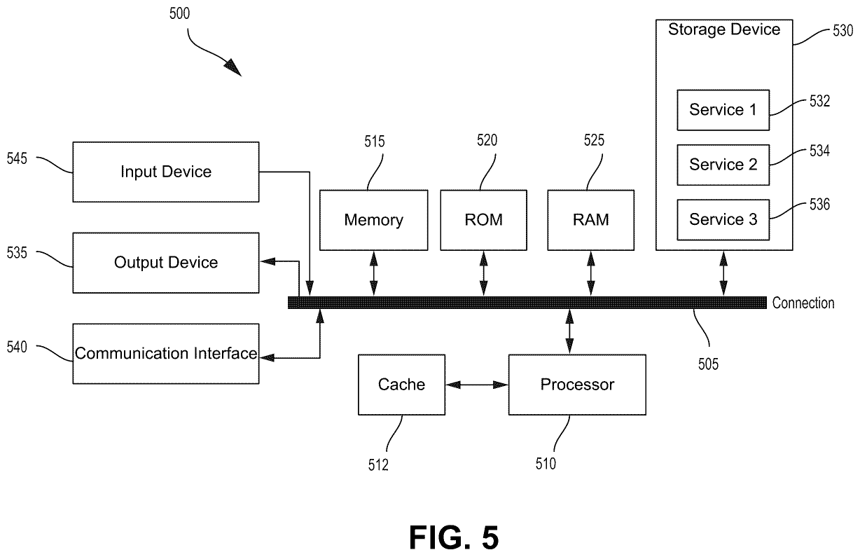

FIG. 3 is a flow diagram illustrating an example of a process 300 for performing multi-scale temporal feature fusion, in accordance with some examples disclosed herein. The operations of the process 300 may be implemented as software components that are executed and run on one or more processors (e.g., processor 510 of FIG. 5 and/or other processor(s), the MSTFF module 100 and/or the classifier 200, or subcomponents thereof). The process 300 can be performed by any device or group of devices. The operations of the process 300 may be implemented as software components that are executed and run on one or more processors (e.g., processor 510 of FIG. 5 and/or other processor(s)).

At block 302, the process 300 includes the one or more processors (e.g., processor 510 of FIG. 5 and/or other processor(s), the MSTFF module 100 and/or the classifier 200, or subcomponents thereof) being configured to: generate (e.g., via a first network or via computing system 500) frame-level features obtained from a set of input frames. In some aspects, the first network can be a two-dimensional convolutional neural network.

At block 304, the process 300 includes the one or more processors (e.g., processor 510 of FIG. 5 and/or other processor(s), the MSTFF module 100 and/or the classifier 200, or subcomponents thereof) being configured to: generate, via a first multi-scale temporal feature fusion engine 208, first local temporal context features from a first neighboring sub-sequence of the set of input frames. The first multi-scale temporal feature fusion engine can apply a first kernel value for generating the first local temporal context features and wherein the second multi-scale temporal feature fusion engine 210 applies a second kernel value for generating the second local temporal context features. In one aspect, the first neighboring sub-sequence of the set of input frames can equal the second neighboring sub-sequence of the set of input frames.

The process to generate, via the first multi-scale temporal feature fusion engine, the first local temporal context features from the first neighboring sub-sequence of the set of input frames further can include one or more of generating, via a first convolutional neural network, first local temporal context features from the set of input frames; generating, via a first cross-attention module 116, a first cross attended feature output based on the first local temporal context features; generating, via a first average pooling module 106, a first average pooling dataset from the set of input frames; and generating the first local temporal context features by adding the first cross attended feature output to the first average pooling dataset.

In one aspect, the first convolutional neural network and the second convolutional neural network each perform a one-dimensional convolution with a respective kernel. In another aspect, the first convolutional neural network and the second convolutional neural network each perform the one-dimensional convolution with the respective kernel to summarize information in consecutive k frames of the set of input frames to generate the first local temporal context features and the second local temporal context features.

In one aspect, the first average pooling module 106 and the second average pooling module 106 each provide information of temporally neighboring frames at a single temporal granularity.

In one aspect, the first cross-attention module 116 generates the first cross attended feature output based on a relationship between a query 112 and a key 110 associated with the set of input frames and wherein the second cross-attention module 116 generates the second cross attended feature output based on the relationship between the query 112 and the key 110 associated with the set of input frames.

At block 306, the process 300 can include the one or more processors being configured to: generate, via a second multi-scale temporal feature fusion engine 210, second local temporal context features from a second neighboring sub-sequence of the set of input frames. The step of generating, via the second multi-scale temporal feature fusion engine 210, the second local temporal context features from the second neighboring sub-sequence of the set of input frames further can include generating, via a second convolutional neural network, second local temporal context features from the set of input frames; generating, via a second cross attention module 116, a second cross attended feature output based on the first local temporal context features; generating, via a second average pooling module 106, a second average pooling dataset 118 from the set of input frames; and generating the second local temporal context features by adding the second cross attended feature output to the second average pooling dataset 118.

In one aspect, the first cross-attention module 116 and the second cross-attention module 116 both transfer data associated with fine-grained features before a one-dimensional convolution on the set of input frames to data associated with coarse-grained features after the one-dimensional convolution on the set of input frames. In another aspect, the first cross attention module 116 and the second cross attention module 116 each convey information from two different temporal granularities.

In one aspect, the two different temporal granularities comprise a frame-level granularity and a tuple-level granularity.

At block 308, the process 300 can include the one or more processors being configured to: classify the set of input frames based on the first local temporal context features and the second local temporal context features. The step in block 308 can further include classifying, via an auxiliary classifier 222, the first local temporal context features and the second local temporal context features during a training process. In one aspect, the auxiliary classifier 222 can include a two-layer multilayer perceptrons (MLP).

An example apparatus for performing video action classification (e.g., recognition, detection, etc.) can include at least one memory and at least one processor coupled to at least one memory. The at least one processor can be configured to: generate, via a first network, frame-level features obtained from a set of input frames; generate, via a first multi-scale temporal feature fusion engine 208, first local temporal context features from a first neighboring sub-sequence of the set of input frames; generate, via a second multi-scale temporal feature fusion engine 210, second local temporal context features from a second neighboring sub-sequence of the set of input frames; and classify the set of input frames based on the first local temporal context features and the second local temporal context features. The video action classification can relate to recognition, detection, or other operations that relate to video actions.

Another example apparatus for performing video classification can include a network 204 (e.g., a neural network) configured to receive a set of video frames and generate frame-level features in consecutive frames from the set of video frames; a first multi-scale temporal feature fusion engine 208 having a first kernel size configured to receive the frame-level features and generate first local context features; a second multi-scale temporal feature fusion engine 210 having a second kernel size configured to receive the frame-level features and generate second local context features; a first temporal-relation cross transformer classifier 218 configured to receive the first local context features and generate a first distance between a query video associated with the set of video frames and sets of support videos; a second temporal-relation cross transformer classifier 220 configured to receive the second local context features and generate a second distance between a query video associated with the set of video frames and the sets of support videos; and a calculating engine configured to calculate a final distance between the query video and the sets of support videos based on the first distance and the second distance.

The use of the first temporal-relation cross transformer classifier 218 and the second temporal-relation cross transformer classifier 220 are by way of example only as other classifiers could be used as well.

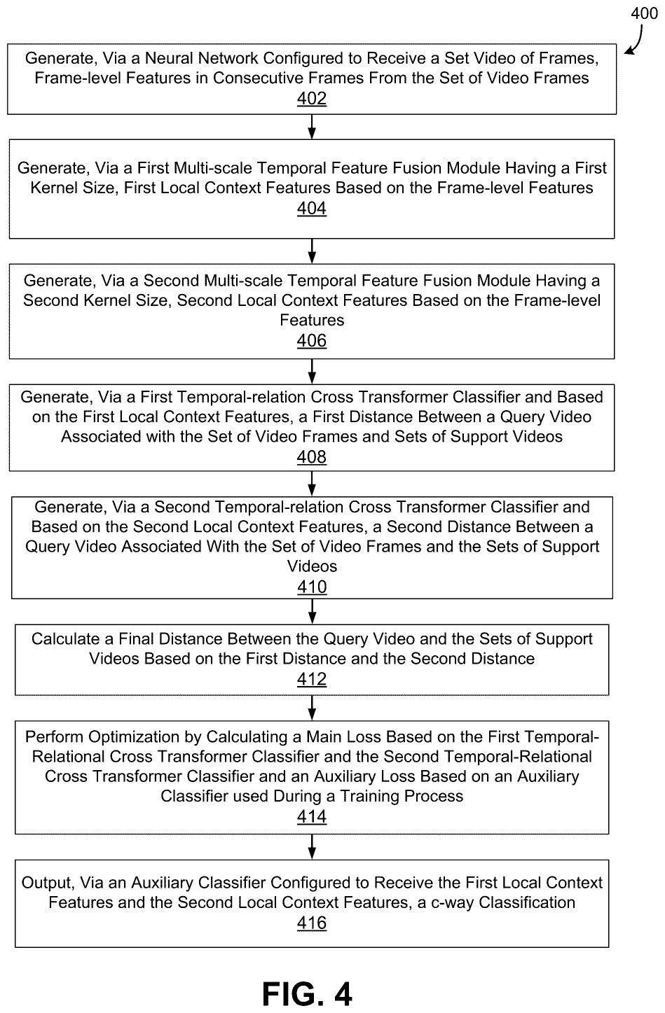

FIG. 4 is a flow diagram illustrating an example of a process 400 for classifying a video using multiple multi-scale temporal feature fusion engines using different kernel sizes. The process 400 can be performed by any device or group of devices. The operations of the process 400 may be implemented as software components that are executed and run on one or more processors (e.g., processor 510 of FIG. 5 and/or other processor(s), the MSTFF module 100 and/or the classifier 200, or subcomponents thereof).

At block 402, the process 400 of performing video classification can include the one or more processors (e.g., processor 510 of FIG. 5 and/or other processor(s), the MSTFF module 100 and/or the classifier 200, or subcomponents thereof) being configured to: generate, via a neural network configured to receive a set of video frames, frame-level features in consecutive frames from the set of video frames.

At block 404, the process 400 can include the one or more processors (e.g., processor 510 of FIG. 5 and/or other processor(s), the MSTFF module 100 and/or the classifier 200, or subcomponents thereof) being configured to: generate, via a first multi-scale temporal feature fusion engine 208 having a first kernel size, first local context features based on the frame-level features.

At block 406, the process 400 can include the one or more processors (e.g., processor 510 of FIG. 5 and/or other processor(s), the MSTFF module 100 and/or the classifier 200, or subcomponents thereof) being configured to: generate, via a second multi-scale temporal feature fusion engine 210 having a second kernel size, second local context features based on the frame-level features.

At block 408, the process 400 can include the one or more processors (e.g., processor 510 of FIG. 5 and/or other processor(s), the MSTFF module 100 and/or the classifier 200, or subcomponents thereof) being configured to: generate, via a first temporal-relation cross transformer classifier 218 and based on the first local context features, a first distance between a query video associated with the set of video frames and sets of support videos.

At block 410, the process 400 can include the one or more processors (e.g., processor 510 of FIG. 5 and/or other processor(s), the MSTFF module 100 and/or the classifier 200, or subcomponents thereof) being configured to: generate, via a second temporal-relation cross transformer classifier 220 and based on the second local context features, a second distance between a query video associated with the set of video frames and the sets of support videos.

At block 412, the process 400 can include the one or more processors (e.g., processor 510 of FIG. 5 and/or other processor(s), the MSTFF module 100 and/or the classifier 200, or subcomponents thereof) being configured to: calculate a final distance between the query video and the sets of support videos based on the first distance and the second distance.

At block 414, the process 400 can include the one or more processors (e.g., processor 510 of FIG. 5 and/or other processor(s), the MSTFF module 100 and/or the classifier 200, or subcomponents thereof) being configured to: perform optimization by calculating a main loss based on the first temporal-relational cross transformer classifier 218 and the second temporal-relational cross transformer classifier 220 and an auxiliary loss based on an auxiliary classifier 220 used during a training process.

At block 416, the process 400 can include the one or more processors (e.g., processor 510 of FIG. 5 and/or other processor(s), the MSTFF module 100 and/or the classifier 200, or subcomponents thereof) being configured to: output, via an auxiliary classifier 222 configured to receive the first local context features and the second local context features, a c-way classification 226. The auxiliary classifier 222 may not be used after training.

In some aspects, a system can include a non-transitory computer-readable medium having stored thereon instructions that, when executed by one or more processors, cause the one or more processors to perform any one or more operations disclosed herein. In another aspect, an apparatus for generating video content classification can include one or more means for performing any one or more operations disclosed herein.

In some aspects, the processes described herein (e.g., process 300, process 400, and/or other process described herein) may be performed by a computing device or apparatus (e.g., a network server, a client device, or any other device, etc. a processor 510 of FIG. 5 and/or other processor(s), the MSTFF module 100 and/or the classifier 200, or subcomponents thereof). For instance, as noted above, the processes 300, 400 may be performed by a computer system. In another example, the process 300 and/or the process 400 may be performed by a computing device with the computing system 500 shown in FIG. 5. For instance, a wireless communication device with the computing architecture shown in FIG. 5 may include the components of the computer system and may implement the operations of FIG. 3 and/or FIG. 4.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 300 and the process 400 are illustrated as a logical flow diagrams, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 300, the process 400, and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 is a diagram illustrating an example of a system for implementing certain aspects of the present technology. In particular, FIG. 5 illustrates an example of computing system 500, which may be for example any computing device making up internal computing system, a remote computing system, a camera, or any component thereof in which the components of the system are in communication with each other using connection 505. Connection 505 may be a physical connection using a bus, or a direct connection into processor 510, such as in a chipset architecture. Connection 505 may also be a virtual connection, networked connection, or logical connection.

In some aspects, computing system 500 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 500 includes at least one processing unit (CPU or processor) 510 and connection 505 that communicatively couples various system components including system memory or cache 515, such as read-only memory (ROM) 520 and random access memory (RAM) 525 to processor 510. Computing system 500 may include a cache 515 of high-speed memory connected directly with, in close proximity to, or integrated as part of processor 510.

Processor 510 may include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which may represent any number of input mechanisms, such as a microphone for speech, a touch-sensitive screen for gesture or graphical input, keyboard, mouse, motion input, speech, etc. Computing system 500 may also include output device 535, which may be one or more of a number of output mechanisms. In some instances, multimodal systems may enable a user to provide multiple types of input/output to communicate with computing system 500.

Computing system 500 may include communications interface 540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 530 may include software services, servers, services, etc., that when the code that defines such software is executed by the processor 510, it causes the system to perform a function. In some aspects, a hardware service that performs a particular function may include the software component stored in a computer-readable medium in connection with the necessary hardware components, such as processor 510, connection 505, output device 535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

This disclosure describes the MSTFF module 100 shown in FIG. 1 and the local temporal context feature-level auxiliary classifier 222 shown in FIG. 2 for few-shot action recognition. Use of the MSTFF module 100 is effective to obtain the richer video descriptor by combining the features in frame-level and local temporal context-level, collaboratively. The suggested (optional) auxiliary classifier 222 shown in FIG. 2 can prevent the model from overfitting to each training episode, and then increase the few-shot action recognition performance in testing.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. An apparatus for performing video action classification, comprising: at least one memory; and at least one processor coupled to at least one memory and configured to: generate, via a first network, frame-level features obtained from a set of input frames; generate, via a first multi-scale temporal feature fusion engine, first local temporal context features from a first neighboring sub-sequence of the set of input frames; generate, via a second multi-scale temporal feature fusion engine, second local temporal context features from a second neighboring sub-sequence of the set of input frames; and classify the set of input frames based on the first local temporal context features and the second local temporal context features.

Aspect 2. The apparatus of Aspect 1, wherein the first multi-scale temporal feature fusion engine applies a first kernel value for generating the first local temporal context features and wherein the second multi-scale temporal feature fusion engine applies a second kernel value for generating the second local temporal context features.

Aspect 3. The apparatus of Aspect 1, wherein at least one processor is further configured to: classify, via an auxiliary classifier, the first local temporal context features and the second local temporal context features during a training process.

Aspect 4. The apparatus of Aspect 3, wherein the auxiliary classifier comprises a two-layer multilayer perceptron (MLP).

Aspect 5. The apparatus of any of Aspects 1 to 5, wherein the first network comprises a two-dimensional convolutional neural network.

Aspect 6. The apparatus of any one of Aspects 1 to 5, wherein at least one processor is further configured to generate, via the first multi-scale temporal feature fusion engine, the first local temporal context features from the first neighboring sub-sequence of the set of input frames by: generating, via a first convolutional neural network, first local temporal context features from the set of input frames; generating, via a first cross attention module, a first cross attended feature output based on the first local temporal context features; generating, via a first average pooling module, a first average pooling dataset from the set of input frames; and generating the first local temporal context features by adding the first cross attended feature output to the first average pooling dataset.

Aspect 7. The apparatus of Aspect 6, wherein at least one processor is further configured to generate, via the second multi-scale temporal feature fusion engine, the second local temporal context features from the second neighboring sub-sequence of the set of input frames by: generating, via a second convolutional neural network, second local temporal context features from the set of input frames; generating, via a second cross attention module, a second cross attended feature output based on the first local temporal context features; generating, via a second average pooling module, a second average pooling dataset from the set of input frames; and generating the second local temporal context features by adding the second cross attended feature output to the second average pooling dataset.

Aspect 8. The apparatus of any one of Aspects 6 or 7, wherein the first neighboring sub-sequence of the set of input frames equals the second neighboring sub-sequence of the set of input frames.

Aspect 9. The apparatus of Aspect 7, wherein the first cross attention module generates the first cross attended feature output based on a relationship between a query 112 and a key 110 associated with the set of input frames and wherein the second cross attention module generates the second cross attended feature output based on the relationship between the query 112 and the key 110 associated with the set of input frames.

Aspect 10. The apparatus of Aspect 9, wherein the first cross attention module and the second cross attention module both transfer data associated with fine-grained features before a one-dimensional convolution on the set of input frames to data associated with coarse-grained features after the one-dimensional convolution on the set of input frames.

Aspect 11. The apparatus of Aspect 10, wherein the first cross attention module and the second cross attention module each convey information from two different temporal granularities.

Aspect 12. The apparatus of Aspect 11, wherein the two different temporal granularities comprise a frame-level granularity and a tuple-level granularity.

Aspect 13. The apparatus of any one of Aspects 7 to 12, wherein the first average pooling module and the second average pooling module each provide information of temporally neighboring frames at a single temporal granularity.

Aspect 14. The apparatus of any one of Aspects 7 to 12, wherein the first convolutional neural network and the second convolutional neural network each perform a one-dimensional convolution with a respective kernel.

Aspect 15. The apparatus of Aspect 14, wherein the first convolutional neural network and the second convolutional neural network each perform the one-dimensional convolution with the respective kernel to summarize information in consecutive k frames of the set of input frames to generate the first local temporal context features and the second local temporal context features.

Aspect 16. A method of classifying video, the method comprising: generating, via a first network, frame-level features obtained from a set of input frames; generating, via a first multi-scale temporal feature fusion engine, first local temporal context features from a first neighboring sub-sequence of the set of input frames; generating, via a second multi-scale temporal feature fusion engine, second local temporal context features from a second neighboring sub-sequence of the set of input frames; and classifying the set of input frames based on the first local temporal context features and the second local temporal context features.

Aspect 17. The method of Aspect 16, wherein the first multi-scale temporal feature fusion engine applies a first kernel value for generating the first local temporal context features and wherein the second multi-scale temporal feature fusion engine applies a second kernel value for generating the second local temporal context features.

Aspect 18. The method of Aspect 16, wherein method includes classifying, via an auxiliary classifier, the first local temporal context features and the second local temporal context features during a training process.

Aspect 19. The method of Aspect 18, wherein the auxiliary classifier comprises a two-layer multilayer perceptron (MLP).

Aspect 20. The method of any of Aspects 16 to 19, wherein the first network comprises a two-dimensional convolutional neural network.

Aspect 21. The method of any one of Aspects 16 to 20, wherein generating, via the first multi-scale temporal feature fusion engine, the first local temporal context features from the first neighboring sub-sequence of the set of input frames further comprises: generating, via a first convolutional neural network, first local temporal context features from the set of input frames; generating, via a first cross attention module, a first cross attended feature output based on the first local temporal context features; generating, via a first average pooling module, a first average pooling dataset from the set of input frames; and generating the first local temporal context features by adding the first cross attended feature output to the first average pooling dataset.

Aspect 22. The method of Aspect 21, wherein generating, via the second multi-scale temporal feature fusion engine, the second local temporal context features from the second neighboring sub-sequence of the set of input frames further comprises: generating, via a second convolutional neural network, second local temporal context features from the set of input frames; generating, via a second cross attention module, a second cross attended feature output based on the first local temporal context features; generating, via a second average pooling module, a second average pooling dataset from the set of input frames; and generating the second local temporal context features by adding the second cross attended feature output to the second average pooling dataset.

Aspect 23. The method of any one of Aspects 20 to 22, wherein the first neighboring sub-sequence of the set of input frames equals the second neighboring sub-sequence of the set of input frames.

Aspect 24. The method of Aspect 22, wherein the first cross attention module generates the first cross attended feature output based on a relationship between a query and a key associated with the set of input frames and wherein the second cross attention module generates the second cross attended feature output based on the relationship between the query 112 and the key 110 associated with the set of input frames.

Aspect 25. The method of Aspect 24, wherein the first cross attention module and the second cross attention module both transfer data associated with fine-grained features before a one-dimensional convolution on the set of input frames to data associated with coarse-grained features after the one-dimensional convolution on the set of input frames.

Aspect 26. The method of Aspect 25, wherein the first cross attention module and the second cross attention module each convey information from two different temporal granularities.

Aspect 27. The method of Aspect 26, wherein the two different temporal granularities comprise a frame-level granularity and a tuple-level granularity.

Aspect 28. The method of any one of Aspects 22 to 27, wherein the first average pooling module and the second average pooling module each provide information of temporally neighboring frames at a single temporal granularity.

Aspect 29. The method of any one of Aspects 22 to 27, wherein the first convolutional neural network and the second convolutional neural network each perform a one-dimensional convolution with a respective kernel.

Aspect 30. The method of Aspect 29, wherein the first convolutional neural network and the second convolutional neural network each perform the one-dimensional convolution with the respective kernel to summarize information in consecutive k frames of the set of input frames to generate the first local temporal context features and the second local temporal context features.

Aspect 31. An apparatus for performing video classification, comprising: a neural network configured to generate frame-level features in consecutive frames from a set of video frames; a first multi-scale temporal feature fusion engine having a first kernel size configured to generate first local context features based on the frame-level features; a second multi-scale temporal feature fusion engine having a second kernel size configured to generate second local context features based on the frame-level features; a first temporal-relation cross transformer classifier configured to generate a first distance between a query video associated with the set of video frames and sets of support videos based on the first local context features; a second temporal-relation cross transformer classifier configured to generate a second distance between a query video associated with the set of video frames and the sets of support videos based on the second local context features; and a calculating engine configured to calculate a final distance between the query video and the sets of support videos based on the first distance and the second distance.

Aspect 32. The apparatus of Aspect 31, wherein the apparatus is optimized by calculating a main loss based on the first temporal-relational cross transformer classifier and the second temporal-relational cross transformer classifier and an auxiliary loss based on an auxiliary classifier used during a training process.

Aspect 33. The apparatus of Aspect 31, further comprising: an auxiliary classifier configured to receive the first local context features and the second local context features and output a multi-way classification.

Aspect 34. The apparatus of Aspect 33, wherein the auxiliary classifier is not used after training the apparatus.

Aspect 35. A method of performing video classification, the method comprising: generating, via a neural network configured to receive a set of video frames, frame-level features in consecutive frames from the set of video frames; generating, via a first multi-scale temporal feature fusion engine having a first kernel size, first local context features based on the frame-level features; generating, via a second multi-scale temporal feature fusion engine having a second kernel size, second local context features based on the frame-level features; generating, via a first temporal-relation cross transformer classifier and based on the first local context features, a first distance between a query video associated with the set of video frames and sets of support videos; generating, via a second temporal-relation cross transformer classifier and based on the second local context features, a second distance between a query video associated with the set of video frames and the sets of support videos; and calculating a final distance between the query video and the sets of support videos based on the first distance and the second distance.

Aspect 36. The method of Aspect 35, further comprising: performing optimization by calculating a main loss based on the first temporal-relational cross transformer classifier and the second temporal-relational cross transformer classifier and an auxiliary loss based on an auxiliary classifier used during a training process.

Aspect 37. The method of Aspect 35, further comprising: outputting, via an auxiliary classifier configured to receive the first local context features and the second local context features, a multi-way classification.

Aspect 38. The method of Aspect 37, wherein the auxiliary classifier is not used after training.

Aspect 39. A non-transitory computer-readable medium having stored thereon instructions that, when executed by one or more processors, cause the one or more processors to perform operations according to any of Aspects 16 to 30 or 35 to 38.

Aspect 40. An apparatus for generating a classification of video content, the apparatus including one or more means for performing operations according to any of Aspects 16 to 30 or 35 to 38.

What is claimed is:

1. An apparatus for performing video action classification, comprising:
at least one memory; and
at least one processor coupled to at least one memory and configured to:
generate, via a first network, frame-level features obtained from a set of input frames;
generate, via a first multi-scale temporal feature fusion engine, first local temporal context features from a first neighboring sub-sequence of the set of input frames;
generate, via a second multi-scale temporal feature fusion engine, second local temporal context features from a second neighboring sub-sequence of the set of input frames; and
classify the set of input frames based on the first local temporal context features and the second local temporal context features.

2. The apparatus of claim 1, wherein the first multi-scale temporal feature fusion engine applies a first kernel value for generating the first local temporal context features and wherein the second multi-scale temporal feature fusion engine applies a second kernel value for generating the second local temporal context features.

3. The apparatus of claim 1, wherein at least one processor is further configured to:
classify, via an auxiliary classifier, the first local temporal context features and the second local temporal context features during a training process.

4. The apparatus of claim 3, wherein the auxiliary classifier comprises a two-layer multilayer perceptron (MLP).

5. The apparatus of claim 1, wherein the first network comprises a two-dimensional convolutional neural network.

6. The apparatus of claim 1, wherein at least one processor is further configured to generate, via the first multi-scale temporal feature fusion engine, the first local temporal context features from the first neighboring sub-sequence of the set of input frames by:
generating, via a first convolutional neural network, first local temporal context features from the set of input frames;
generating, via a first cross attention module, a first cross attended feature output based on the first local temporal context features;
generating, via a first average pooling module, a first average pooling dataset from the set of input frames; and
generating the first local temporal context features by adding the first cross attended feature output to the first average pooling dataset.

7. The apparatus of claim 6, wherein at least one processor is further configured to generate, via the second multi-scale temporal feature fusion engine, the second local temporal context features from the second neighboring sub-sequence of the set of input frames by:
generating, via a second convolutional neural network, second local temporal context features from the set of input frames;
generating, via a second cross attention module, a second cross attended feature output based on the first local temporal context features;
generating, via a second average pooling module, a second average pooling dataset from the set of input frames; and
generating the second local temporal context features by adding the second cross attended feature output to the second average pooling dataset.

8. The apparatus of claim 6, wherein the first neighboring sub-sequence of the set of input frames equals the second neighboring sub-sequence of the set of input frames.

9. The apparatus of claim 7, wherein the first cross attention module generates the first cross attended feature output based on a relationship between a query and a key associated with the set of input frames and wherein the second cross attention module generates the second cross attended feature output based on the relationship between the query and the key associated with the set of input frames.

10. The apparatus of claim 9, wherein the first cross attention module and the second cross attention module both transfer data associated with fine-grained features before a one-dimensional convolution on the set of input frames to data associated with coarse-grained features after the one-dimensional convolution on the set of input frames.

11. The apparatus of claim 10, wherein the first cross attention module and the second cross attention module each convey information from two different temporal granularities.

12. The apparatus of claim 11, wherein the two different temporal granularities comprise a frame-level granularity and a tuple-level granularity.

13. The apparatus of claim 7, wherein the first average pooling module and the second average pooling module each provide information of temporally neighboring frames at a single temporal granularity.

14. The apparatus of claim 7, wherein the first convolutional neural network and the second convolutional neural network each perform a one-dimensional convolution with a respective kernel.

15. The apparatus of claim 14, wherein the first convolutional neural network and the second convolutional neural network each perform the one-dimensional convolution with the respective kernel to summarize information in consecutive k frames of the set of input frames to generate the first local temporal context features and the second local temporal context features.

16. A method of classifying video, the method comprising:
generating, via a first network, frame-level features obtained from a set of input frames;
generating, via a first multi-scale temporal feature fusion engine, first local temporal context features from a first neighboring sub-sequence of the set of input frames;
generating, via a second multi-scale temporal feature fusion engine, second local temporal context features from a second neighboring sub-sequence of the set of input frames; and
classifying the set of input frames based on the first local temporal context features and the second local temporal context features.

17. The method of claim 16, wherein the first multi-scale temporal feature fusion engine applies a first kernel value for generating the first local temporal context features and wherein the second multi-scale temporal feature fusion engine applies a second kernel value for generating the second local temporal context features.

18. The method of claim 16, wherein the method further comprises:
classifying, via an auxiliary classifier, the first local temporal context features and the second local temporal context features during a training process.

19. The method of claim 18, wherein the auxiliary classifier comprises a two-layer multilayer perceptron (MLP).

20. The method of claim 16, wherein the first network comprises a two-dimensional convolutional neural network.

21. The method of claim 16, wherein generating, via the first multi-scale temporal feature fusion engine, the first local temporal context features from the first neighboring sub-sequence of the set of input frames further comprises:
generating, via a first convolutional neural network, first local temporal context features from the set of input frames;
generating, via a first cross attention module, a first cross attended feature output based on the first local temporal context features;
generating, via a first average pooling module, a first average pooling dataset from the set of input frames; and
generating the first local temporal context features by adding the first cross attended feature output to the first average pooling dataset.

22. The method of claim 21, wherein generating, via the second multi-scale temporal feature fusion engine, the second local temporal context features from the second neighboring sub-sequence of the set of input frames further comprises:
generating, via a second convolutional neural network, second local temporal context features from the set of input frames;
generating, via a second cross attention module, a second cross attended feature output based on the first local temporal context features;
generating, via a second average pooling module, a second average pooling dataset from the set of input frames; and
generating the second local temporal context features by adding the second cross attended feature output to the second average pooling dataset.

23. The method of claim 20, wherein the first neighboring sub-sequence of the set of input frames equals the second neighboring sub-sequence of the set of input frames.

24. The method of claim 22, wherein the first cross attention module generates the first cross attended feature output based on a relationship between a query and a key associated with the set of input frames and wherein the second cross attention module generates the second cross attended feature output based on the relationship between the query and the key associated with the set of input frames.

25. The method of claim 24, wherein the first cross attention module and the second cross attention module both transfer data associated with fine-grained features before a one-dimensional convolution on the set of input frames to data associated with coarse-grained features after the one-dimensional convolution on the set of input frames.

26. The method of claim 25, wherein:
the first cross attention module and the second cross attention module each convey information from two different temporal granularities;
the two different temporal granularities comprise a frame-level granularity and a tuple-level granularity; and
the first average pooling module and the second average pooling module each provide information of temporally neighboring frames at a single temporal granularity.

27. The method of claim 22, wherein the first convolutional neural network and the second convolutional neural network each perform a one-dimensional convolution with a respective kernel.

28. The method of claim 27, wherein the first convolutional neural network and the second convolutional neural network each perform the one-dimensional convolution with the respective kernel to summarize information in consecutive k frames of the set of input frames to generate the first local temporal context features and the second local temporal context features.

29. An apparatus for performing video classification, comprising:
a neural network configured to generate frame-level features in consecutive frames from a set of video frames;
a first multi-scale temporal feature fusion engine having a first kernel size and configured to generate first local context features based on the frame-level features;
a second multi-scale temporal feature fusion engine having a second kernel size and configured to generate second local context features based on the frame-level features;
a first temporal-relation cross transformer classifier configured to generate a first distance between a query video associated with the set of video frames and sets of support videos based on the first local context features;
a second temporal-relation cross transformer classifier configured to generate a second distance between a query video associated with the set of video frames and the sets of support videos based on the second local context features; and
a calculating engine configured to calculate a final distance between the query video and the sets of support videos based on the first distance and the second distance.

30. A method of performing video classification, the method comprising:
generating, via a neural network configured to receive a set of video frames, frame-level features in consecutive frames from the set of video frames;
generating, via a first multi-scale temporal feature fusion engine having a first kernel size, first local context features based on the frame-level features;
generating, via a second multi-scale temporal feature fusion engine having a second kernel size, second local context features based on the frame-level features;
generating, via a first temporal-relation cross transformer classifier and based on the first local context features, a first distance between a query video associated with the set of video frames and sets of support videos;
generating, via a second temporal-relation cross transformer classifier and based on the second local context features, a second distance between a query video associated with the set of video frames and the sets of support videos; and
calculating a final distance between the query video and the sets of support videos based on the first distance and the second distance.
